(19) United States
(12) Patent Application Publication
(10) Pub. No.: US 2007/0122571 A1
(43) Pub. Date: May 31, 2007

(54) BINDER AND COATING SLIP FOR COATING BASE PAPER IN INKJET PAPER PRODUCTION

(75) Inventors: Josef ECKL, Augsburg (DE); Alexander RAAB, Neckarsteinach (DE); Dirk KISTERS, Lobbach (DE); Berthold KOHLER, Neckargemund (DE)

Correspondence Address: LEYDIG VOIT & MAYER, LTD, 700 THIRTEENTH ST. NW, SUITE 300, WASHINGTON, DC, 20005-3960, US

(73) Assignee: GELITA AG, Eberbach (DE)

(21) Appl. No.: 11/538,586

(22) Filed: Oct. 4, 2006

Related U.S. Application Data
(63) Continuation-in-part of application No. PCT/EP05/00630, filed on Jan. 22, 2005.

(30) Foreign Application Priority Data
Apr. 6, 2004 (DE) 10 2004 018 432.1

(51) Int. Cl. B41M 5/40

(52) U.S. Cl. 428/32.38

(57) ABSTRACT

A binder for coating slips is disclosed comprising a first binder component, the first binder component providing the solids content of gelatine in the binder, one or more father binder components which are selected from the group consisting of vinyl alcohol polymers vinyl alcohol copolymers, carbohydrates, and carbohydrate derivatives, the one or more further binder components providing, summed together, the solids content of the one or more further binder components in the binder; the solids content of the gelatine in the binder being greater than the solids content of the one or more further binder components in the binder.

### CROSS REFERENCE TO RELATED APPLICATIONS

This application is a continuation-in-part of international application number PCT/EP2005/000630, filed on Jan. 22, 2005, which claims the benefit of German patent application number 10 2004 018 432.1, filed on Apr. 6, 2004, which are both incorporated by reference.

### BACKGROUND OF THE INVENTION

The invention relates to a binder for coating slips, in particular water-based coating slips, which are used for coating base paper in inkjet paper production, to coating slips which contain such binders as well as to inkjet papers produced in this way and to a method for producing them.

A wide variety of inkjet papers of different qualities and based on different paper coatings are known. Photographic papers especially have received particular attention in the development of inkjet papers, but are very expensive and, as a result, are not suitable for “normal” color prints, as are frequently required for everyday office purposes, for reasons of cost.

On the other hand, standard papers often produce only inadequate color depths in inkjet printing, have excessively long drying times and/or lack satisfactory edge definition.

In addition, photographic papers generally have a basis weight that is too high for customary office applications.

BRIEF SUMMARY OF THE INVENTION

It is an object of the invention to propose a binder for coating slips that allow the production of inexpensive inkjet papers which exhibit relatively high color depths with inkjet inks and consequently can in many cases replace the higher-grade and expensive qualities of inkjet photographic papers.

This object is achieved according to the invention in the case of a binder of the type described at the beginning by the binder having a solids content of gelatine and one or more further binder components, the binder comprising a first binder component providing the solids content of gelatine in the binder; one or more further binder components which are selected from vinyl alcohol polymers, vinyl alcohol copolymers, carbohydrates and carbohydrate derivatives, the one or more further binder components providing, summed together, the solids content of the one or more further binder components in the binder; the solids content of the gelatine in the binder being greater than the solids content of the one or more further binder components in the binder.

### DETAILED DESCRIPTION OF THE INVENTION

Although gelatine has already been used in many cases for ink accepting layers of photographic papers, they are complicated to produce and consequently are correspondingly expensive.

Gelatine as a binder in ink accepting layers does ensure an excellent color depth, but the edge definition on matt papers is not always satisfactory.

Similarly, ink accepting layers based on polyvinyl alcohol (PVA) are known, but often have only low color depth.

Binders in which gelatine represents the main element of the binder, as provided by the invention, amazingly show very good results with respect to color depth and are optimized with regard to edge definition when the gelatine is mixed with the other components of the binder.

This makes it possible to produce coating slips that allow the production of inexpensive qualities of paper for inkjet printing which are at least of moderate quality with respect to color depth and require only low coating weights for this.

This ultimately has the consequence that relatively low-cost installations can be used for paper production, which gives the paper further cost advantages and consequently a broader range of applications in inkjet color printing.

In combination with the main constituent gelatine, not only vinyl alcohol polymers and copolymers, but also carbohydrates and their derivatives, can be used to improve the edge definition and the processing behavior of the coating slip without the color depth that is ensured by the gelatine being markedly impaired as a result.

Preferably the one or more further binder components comprise polyvinyl alcohol (PVA) and/or partly hydrolyzed polyvinyl alcohol.

Polyvinyl alcohol/polyalkylene oxide copolymers are also a preferred further binder component.

Carbohydrates, particularly starch, and carbohydrate derivatives, particularly starch derivates, are preferred further binder components.

When carbohydrate derivatives, in particular starch derivatives, are used as further components of the binder, hydroxyalkylated starch derivatives, such as, for example, hydroxypropyl starch derivatives, are preferred.

The solids content of gelatine in relation to the solids content of the one or more further binder components is preferably used in a ratio of from 1.1:1 to 2.5:1.

On the other hand, in order to optimize the processability of the coating slip, the fraction of carbohydrate or carbohydrate derivative(s) as a proportion of the solids content of all the binder components, i.e., also the binder component gelatine, is preferably at least 5% by weight, more preferably a solids content fraction of the carbohydrates and/or the carbohydrate derivatives as a proportion of the solids content of all the binder components of about 8 to 11% by weight is used.

As already stated at the beginning, the invention also relates to a coating slip for coating base paper in inkjet paper production, which comprises a binder of the present invention and one or more inorganic pigments.

The binder/pigment ratio is preferably 1:1 to 1:3, in particular 1:1.3 to 1:2.5.

For further improvement of the color fixing, the coating slip may also comprise a cationizing agent.

Already distinct color fixing is obtained by the use of gelatine alone in the binder, representing a polyelectrolyte, so that ultimately optimization can be further achieved by means of the cationizing agent.

The cationizing agents are preferably selected from cationic polyacrylates, chitosan products and derivatives of chitosan, poly-DADMAC, polyamines, polyamides other than gelatine and polyimines.

In the coating slip, the cationizing agents are preferably used in an amount of 2 to 17% by weight with respect to the solids content of the coating slip.

To allow the use of coating installations in which complicated preparation of the coating slip is not possible, an agent for stabilizing the inorganic pigment or pigments in the binder is preferably added to the coating slip. This stabilizes the suspension of the pigments in the binder. One way of doing this is simply by a fraction of carbohydrate or carbohydrate derivative. Specific stabilizing agents for stabilizing the suspension of the pigments in the binder are preferably selected from propylene oxide/ethylene oxide block copolymers and polyvinyl pyrrolidone.

About 0.5 to 2% by weight with respect to the pigment content is generally adequate for stabilizing the pigment suspension.

The pigments themselves are preferably selected from aluminum silicates, amorphous silica, calcium carbonate, bentonite, zeolites, talc, barium sulfate, calcium sulfate, titanium dioxide, satin white, aluminum hydroxide and kaolin (clay).

The invention also relates to an inkjet paper in which the coating slip according to the invention is applied to one side or both sides of the base paper. Coating weights per side of up to 15 g/m² and more are possible, although coating weights of up to 7 g/m², in particular up to 6 g/m², on each side of the paper are adequate for the qualities aimed at less expensive market segments.

The coating slips of the present invention are aqueous systems with solids contents of about 25 to 50% by weight. Deviations below and above these are readily possible. The viscosity is preferably set in the range from 700 to 2500 mPas. Deviations from this range, below and above it, are not particularly critical.

The present invention shows that gelatine is a binder that is very well suited for the production of inkjet coating slips.

The special properties of gelatine as an organic and fully biodegradable binder, which as a regenerative raw material also satisfies ecological requirements, provide possibilities for the production of low-cost inkjet coating slips for the production of improved office papers that can produce at least moderate quality in color printing.

In this case, the amphoteric character of the gelatine plays a special role, the pronounced tendency toward gel formation and the resultant immobilization of the coating slip and inkjet printing ink on the surface of the paper allowing the use of low-cost pigments, such as for example precipitated calcium carbonate or zeolite, with good results. Such very inexpensive pigments have not previously been successfully used in inkjet paper production, in particular in the production of photographic papers that can be printed on by inkjet printers.

In the case of higher coating weights, the quality level of the paper can be increased significantly further, up to qualities which correspond to the high-quality conventional inkjet papers.

Finally, the invention relates to a method for producing inkjet papers. Simply by coating base paper (on one or both sides) with the coating slip according to the invention, it is possible to produce an inkjet paper that delivers a print of at least moderate quality.

In addition, the coating slip according to the invention can be applied to the paper by so-called film presses, and it is consequently possible to accomplish a production process in which the base paper can be coated after its production with coating weights of up to 7 g/m² directly and if need be on both sides. In comparison with application of the coating with a blade, this saves an additional working step and an additional drying step, in the case of papers coated on both sides indeed a further additional coating step and drying step. It is likewise possible to dispense with treatment of the paper by means of a size press.

The coating in the film presses generally takes place at temperatures around 60° C., temperatures at which the gelatine does not yet gel. This additionally simplifies the application of the gelatine-based coating slip concept according to the invention.

Comparably low-cost and high-quality prints are not possible with other binders, such as, for example, polyvinyl alcohol or gelatine on its own.

These and farther advantages of the invention are explained in more detail below on the basis of examples.

### EXAMPLES

The exemplary embodiments 1 to 4 that are compiled in Table I show that significantly superior inkjet printing results can be achieved with low-cost coatings according to the invention of a base paper as compared with conventional general-purpose office papers (photocopy/laser and inkjet printing papers for monochrome applications).

TABLE 1

| | Binder component | | | | | Pigments | | | | | |
|---|---|---|---|---|---|---|---|---|---|---|---|
| | | Starch/starch | | Wetting and | | | CaCO₃ | | | Solid | |
| Exam- | | derivative | | stabilizing | Cationizing | SiO₂/ | preci- | | | content | Viscosity |
| ples | Gelatine | Emsol K55 | PVA | agent | agent | Al₂O₃ | pitated | Bentonite | Zeolite | [% by weight] | [mPas] |
| 1 | 30 | | 20 | 1 | 6 | 30 | 70 | | | 30 | 1350 |
| 2 | 30 | 20 | | 1 | 9 | 100 | | | | 29 | 1360 |
| 3 | 30 | 20 | | 1 | 6 | 100 | | | | 29 | 1450 |
| 4 | 30 | | 20 | 1 | 9 | | | 100 | | 31 | 1660 |

Unless otherwise specified, all numerical values are in parts by weight

The following properties in particular are improved in comparison with general-purpose papers:
color densities and edge definition;
folding endurance.

These advantages are also found in comparison with special conventional inkjet papers of moderate quality (for example papers coated with PVA binder), which serve here as a comparative example.

The examples show at the same time that these results can be achieved not only with high-grade pigments, in the form of amorphous precipitated silica (for example Sipemat 570) or silicon dioxide with aluminum oxide fractions (for example Aerosil Mox 170) in the coating (grouped together in the tables as SiO₂/Al₂O₃), but also with very inexpensive pigments, such as for example precipitated Ca carbonate, bentonites (for example Jetsil SK 50) and zeolites (for example zeolite 4A).

In all the examples 1 to 14, a low-bloom gelatine (Gelita® image1 NP) was used as the gelatine, modified potato starch ether Emsol K 55 (low viscosity) was used as the starch or starch derivative and Moviol 4-98 was used as the PVA binder component.

The aforementioned gelatine is a type B gelatine, of low bloom, obtained from bone material. Other low-bloom gelatine types can similarly be used, while slight adaptations of the formulations (concentration; viscosity) are to be recommended if high-bloom gelatine types are used.

Lumiten PR 8540, a polyvinyl pyrrolidone, was used as the wetting and stabilizing agent.

The cationizing agents used are either Catiofast CS or Induquat ECR 69L, a cationic polyacrylate.

The color densities were determined by means of a densitometer (Getrag SPM 50).

The light fastness was tested after accelerated aging in a so-called Xenotester (irradiating intensities of 1154 W/m²) at 23° C. and 50% relative humidity over 24 h.

In some applications, however, an excessively pronounced tendency toward linting is found when formulations of the examples in Table 1 are used, an indication that pigment on the surface is not adequately bound by the binder matrix.

The examples compiled in Table 2 suppress Tinting by their formulations to such an extent that even applications that are critical in this respect can be covered by the coated papers. A small fraction of a starch preparation, such as for example Emsol K115 (potato starch ether of medium viscosity), is sufficient to help here.

TABLE 2

| | Binder component | | | | | Pigments | | | | | |
|---|---|---|---|---|---|---|---|---|---|---|---|
| Ex- | | Starch/starch | | Wetting and | | | CaCO₃ | | | Solid | Vis- |
| am- | | derivative Emsol | | stabilizing | Cationizing | SiO₂/ | preci- | | | content | cosity |
| ples | Gelatine | K55 or K115 | PVA | agent | agent | Al₂O₃ | pitated | Bentonite | Zeolite | [% by weight] | [mPas] |
| 5 | 35 | 5K | 25 | 1 | 10 | 30 | | | 70 | 30 | 808 |
| 6 | 35 | 5K | 25 | 1 | 9 | 30 | 70 | | | 30 | 1580 |
| 7 | 30 | 20 + 5K | | 1 | 9 | 100 | | | | 28 | 1350 |
| 8 | 30 | 20 + 5K | | 1 | 6 | 100 | | | | 29 | 1240 |
| 9 | 30 | 5K | 20 | 1 | 9 | | | 100 | | 31 | 1650 |
| Com- | | | 50 | 1 | 10 | 100 | | | | 25 | 1130 |
| par- | | | | | | | | | | | |
| ison | | | | | | | | | | | |

Unless otherwise specified, all numerical values are in parts by weight
K = Emsol K115 additive

The additive was not found to cause any impairment of the advantageous properties already achieved with the examples of Table 1.

Papers were tested with respect to various properties with the formulations given as examples in Table 2 in comparison with a PVA standard paper (comparison paper) and the reference paper (866 INKJET PAPER DT PLOT, 100-120 g/m², made by the Cham Paper Group), which represents a very high-grade matt inkjet paper. The test results are compiled in Table 3.

Likewise on the basis of the basic formulations of Table 1, formulations that are suitable for application to the base paper by means of a film press were developed. The formulations of these further examples are compiled in Table 4.

Applying the coatings with the film press instead of with a doctor blade has several advantages, making it possible in particular for production to be carried out more efficiently, in that the coating can be applied to the base paper coming directly from production, if desired on both sides in one working step. This dispenses with laborious repeated handling of the paper between separate working steps and similarly does away with multiple drying steps and the use of a size press.

With the papers produced with the formulations of the examples of Table 4, the test values compiled in Table 5 are obtained.

The coating weights that can be achieved by means of a film press are generally entirely adequate to obtain very high-grade inkjet papers that can be produced very cost-effectively. As can be seen from Table 5, the printing quality does not in any way suffer as a result, on the contrary it is possible to obtain papers which are only of a slightly lower quality than the high-grade reference paper. If the amount of the coating is increased, further increases in quality can be achieved.

TABLE 3

| | | | | | | | | Coating | |
|---|---|---|---|---|---|---|---|---|---|
| | Color density comparison | | | | | Folding | | weight | |
| Examples | Black | Yellow | Magenta | Cyan | ΣΔ | endurance | Light fastness | [g/m²] | Miscellaneous |
| Reference | 1.66 | 1.50 | 1.34 | 1.50 | 0 | ++ | Reference | | Reference |
| 5 | 1.31 | 1.12 | 1.04 | 1.13 | 1.40 | ++ | Slightly | 4-6 | |
| | | | | | | | inferior | | |
| 6 | | | | | | ++ | Comparable | 4-8 | |
| 7 | | | | | | + | Comparable | 4-10 | |
| 8 | | | | | | + | Comparable | 4-7 | |
| 9 | | | | | | ++ | Comparable | 5-7 | |
| Comparison | 1.39 | 1.11 | 1.03 | 1.21 | 1.26 | ++ | Comparable | 3-5 | Inferior coating adhesion |
| | | | | | | | | | and water resistance |

++ very good
+ good
no entry: no data available

TABLE 4

| | Binder component | | | | | | | | | | |
|---|---|---|---|---|---|---|---|---|---|---|---|
| | | Starch/starch | | | | Pigments | | | | | |
| | | derivative | | Wetting and | | | CaCO₃ | | | | |
| Exam- | | Emsol K55 | | stabilizing | Cationizing | SiO₂/ | preci- | | | Solid content | Viscosity |
| ples | Gelatine | or K115 | PVA | agent | agent | Al₂O₃ | pitated | Bentonite | Zeolite | [% by weight] | [mPas] |
| 10 | 30 | 20 + 5K | | 1 | 10 | 100 | | | | 28 | 1430 |
| 11 | 30 | 5K | 20 | 1 | 15 | | | 100 | | 31 | 1320 |
| 12 | 40 | 25 | | 1 | 15 | 100 | | | | 28 | 1400 |
| 13 | 40 | 5K | 25 | 1 | 15 | 30 | | | 70 | 31 | 1050 |
| 14 | 40 | 25 | | 1 | 15 | 30 | | | 70 | 31 | 760 |

Unless otherwise specified, all numerical values are in parts by Weight
K = Emsol K115 additive

TABLE 5

| | | | | | | | | Coating | |
|---|---|---|---|---|---|---|---|---|---|
| | Color density comparison | | | | | Folding | | weight | |
| Examples | Black | Yellow | Magenta | Cyan | ΣΔ | endurance | Light fastness | [g/m₂] | Miscellaneous |
| Reference | 1.66 | 1.50 | 1.34 | 1.50 | 0 | ++ | Reference | | Reference |
| 10 | 1.50 | 1.23 | 1.17 | 1.35 | 0.75 | + | Somewhat | 3-5 | Very good coating adhesion |
| | | | | | | | inferior | | and water resistance |
| 11 | 1.27 | 1.08 | 0.97 | 1.10 | 1.54 | ++ | Comparable | 3-5 | Good coating adhesion |
| | | | | | | | | | and water resistance |
| 12 | 1.46 | 1.11 | 1.11 | 1.31 | 1.01 | + | | 3-5 | |
| 13 | 1.27 | 1.05 | 1.02 | 1.14 | 1.52 | | | 3-5 | |
| 14 | 1.14 | 1.02 | 1.02 | 1.09 | 1.53 | | | 3-5 | |
| Comparison | 1.39 | 1.11 | 1.03 | 1.21 | 1.26 | ++ | Comparable | 3-5 | Inferior coating adhesion |
| | | | | | | | | | and water resistance |
| Office | 1.10 | 0.93 | 0.89 | 1.00 | 2.08 | | | | |

++ very good
+ good
no entry: no data available

The above examples were all produced with the same base paper suitable for inkjet printing. A comparison with results achieved using other base papers does show certain differences, but always the same trend, so that when alternative base papers are used it is possible by making slight modifications to the formulations for them to be adapted to the different properties of the other base paper.

1. A binder for water-based coating slips, which are used for coating base paper in inkjet paper production, the binder having a solids content of gelatine and one or more further binder components, the binder comprising:
a first binder component, the first binder component providing the solids content of gelatine in the binder;
one or more further binder components which are selected from the group consisting of vinyl alcohol polymers, vinyl alcohol copolymers, carbohydrates, and carbohydrate derivatives, the one or more further binder components providing, summed together, the solids content of the one or more further binder components in the binder;
the solids content of the gelatine in the binder being greater than the solids content of the one or more further binder components in the binder.

2. The binder according to claim 1, wherein the vinyl alcohol polymer is polyvinyl alcohol (PVA) and/or partly hydrolyzed polyvinyl alcohol.

3. The binder according to claim l , wherein the vinyl alcohol copolymers are selected from polyvinyl alcohol/polyalkylene oxide copolymers.

4. The binder according to claim 1, wherein the carbohydrates and carbohydrate derivatives are selected from the group consisting of starch and starch derivatives.

5. The binder according to claim 1, having a ratio of the solids content of the gelatine in relation to the solids content of the one or more further binder components of 1.1:1 to 2.5:1.

6. The binder according to claim 1, wherein the further binder components comprise carbohydrates or carbohydrate derivatives, providing a solids content fraction, wherein the fraction provided by the arbohydrates or carbohydrate derivatives as a proportion of the solids content of all the binder components is at least 5% by weight.

7. A coating slip for coating base paper in inkjet paper production comprising:
a binder according to claim 1; and
one or more inorganic pigments.

8. The coating slip according to claim 7, further comprising a cationizing agent.

9. The coating slip according to claim 7, further comprising an agent for stabilizing the inorganic pigment or pigments in the binder.

10. The coating slip according to claim 7, wherein the pigments are selected from the group consisting of aluminum silicates, amorphous silica, calcium carbonate, bentonite, zeolites, talc, barium sulfate, calcium sulfate, titanium dioxide, satin white, aluminum hydroxide and kaolin.

11. The coating slip according to claim 8, wherein the cationizing agent is selected from the group consisting of cationic polyacrylates, chitosan and chitosan derivatives, poly-DADMAC, polyamines, polyamides other than gelatine, and polyimines.

12. The coating slip according to claim 9, wherein the stabilizing agent is selected from the group consisting of propylene oxide/ethylene oxide block copolymers and polyvinyl pyrrolidone.

13. An inkjet paper, comprising:
a base paper having first and second surfaces; and,
a coating slip comprising one or more inorganic pigments and a binder having a solids content of gelatine and one or more further binder components, the binder comprising:
a first binder component the first binder component providing the solids content of gelatine in the binder; and,
one or more further binder components which are selected from the group consisting of vinyl alcohol polymers, vinyl alcohol-copolymers, carbohydrates, and carbohydrate derivatives, the one or more further binder components providing, summed together, the solids content of the one or more further binder components in the binder the solids content of the gelatine in the binder being greater than the solids content of the one or more further binder components in the binder;
wherein at least one surface of the base paper is coated with the coating slip.

14. The inket paper according to claim 13, wherein up to 15 g/m² of the coating slip is coated on each surface of the base paper.

15. The inkjet paper according to claim 13, wherein at most 7 g/m² of the coating slip is coated on each surface of the base paper.

16. A method for producing inkjet paper, comprising:
coating a base paper having first and second surfaces on at least one surface with a coating slip comprising one or more inorganic pigments and a binder having a solids content of gelatine and one or more further binder components, the binder comprising:
a first binder component, the first binder component providing the solids content of gelatine in the binder; and,
one or more further binder components which are selected from the group consisting of vinyl alcohol polymers, vinyl alcohol copolymers, carbohydrates, and carbohydrate derivatives, the one or more further binder components providing, summed together, the solids content of the one or more further binder components in the binder, the solids content of the gelatine in the binder being greater than the solids content of the one or more further binder components in the binder;

17. The method according to claim 16, wherein the coating of the base paper is carried out in a film press.

18. The method according to claim 17, wherein the base paper is coated with the coating slip on both surfaces simultaneously.

19. The method according to claim 17, wherein the coating slip is applied by the film press to the base paper directly after its production.

20. The binder according to claim 4, wherein the further binder components comprise hydroxyalkylated starch derivatives.
